(19) United States
(12) Patent Application Publication
(10) Pub. No.: US 2017/0134288 A1
(43) Pub. Date: May 11, 2017

(54) COMMUNICATION DEVICE, NETWORK, AND RESOURCE UTILIZATION METHOD

(71) Applicant: NEC Corporation, Tokyo (JP)

(72) Inventor: Tomoshige FUNASAKI, Tokyo (JP)

(73) Assignee: NEC Corporation, Tokyo (JP)

(21) Appl. No.: 15/129,586

(22) PCT Filed: Mar. 16, 2015
(86) PCT No.: PCT/JP2015/001428

§ 371 Date: Sep. 27, 2016

(30) Foreign Application Priority Data
Mar. 28, 2014 (JP) 2014-068919

(51) Int. Cl. H04L 12/803; H04L 12/721; H04L 12/707

(52) U.S. Cl. CPC H04L 47/125; H04L 45/24; H04L 45/70

(57) ABSTRACT

In order to solve the problem that communication resources (a communication device and a link) in a network are not always efficiently used, this network is provided with a first communication device for transmitting data of a set path and a second communication device for receiving data of the path, wherein a path is set for the second communication device, and the second communication device is provided with a detection means for outputting a first signal in correspondence to a change in the bandwidth of a link connecting the second communication device and an other communication device for which the path is set, and a change indication means for determining, upon input of the first signal, a communication traffic for each path such that the total traffic after a change does not exceed the bandwidth of the link, and transmitting the determined communication traffic to a communication device for transmitting data of the path, the first communication device transmitting data of the path within the received communication traffic pertaining to the path.

### TECHNICAL FIELD

The present invention relates to a communication device, a network, and a resource utilization method, and relates particularly to a communication device, a network, and a resource utilization method for efficiently utilizing communication resources.

### BACKGROUND ART

Networks in which multiple communication devices are connected to each other via links each having a band changing with the elapse of time (hereinafter referred to as a “variable link”) are typically known. The above-described variable link is, for example, a wireless link.

In the above-described network, a path is set between communication devices, and communication devices on the path sequentially transmit data to the communication device at the end point of the path via the variable links.

For example, FIG. 1 is a diagram illustrating an example of a configuration of a typical network. As illustrated in FIG. 1, a path 60 is set between a communication device 51 and a communication device 56, and a path 61 is set between a communication device 52 and a communication device 56. In this configuration, communication devices 51, 53, and 54 on the path 60 sequentially transmit data on the path 60 (at 300 Mbps, for example) to the communication device 56 at the end point of the path via variable links 70, 72, and 73. Similarly, communication devices 52, 53, and 54 on the path 61 sequentially transmit data on the path 61 (data at 300 Mbps, for example) to the communication device 56 at the end point of the path via variable links 71, 72, and 73.

PTL 1 discloses a technique related to data transmission.

In a network according to PTL 1, a network edge node (corresponding to the above-described “communication device”) monitors the bandwidth (corresponding to the above-described “band”) of a link for which a first transmission path (currently used path) is set among links connected to the network edge node. Upon detection of a change in bandwidth of the monitoring link, the network edge node switches part of the service on a first transmission path (currently used path) to a second transmission path (standby path).

With the above-described configuration and operations, the network according to PTL 1 is capable of preventing a decrease in service quality even when the band of a link has decreased significantly.

### CITATION LIST

### Patent Literature

[PTL 1] Japanese Translation of PCT International Application Publication No. JP-T-2013-503518

[PTL 2] WO 2011/070940

[PTL 3] WO 2010/032844

[PTL 4] Japanese Laid-open Patent Publication No. 2011-188443

### SUMMARY OF INVENTION

### Technical Problem

Typical networks including the network in PTL 1 have a problem of not necessarily utilizing communication resources (communication devices and links) in the network efficiently.

The reasons are described below.

First, when the band of a variable link decreases in a typical network, a communication device that transmits data to the variable link discards data that is not possible to transmit due to the decrease of the band. For example, when the band of the variable link 72 decreases from 1 Gbps to 200 Mbps in the typical network illustrated in FIG. 1, the communication device 53 can only transmit data corresponding to 200 Mbps to the variable link 72. Consequently, the communication device 53 discards the data corresponding to 400 Mbps which is not possible to transmit, out of the data corresponding to 600 Mbps in total on the paths 60 and 61 received from the communication devices 51 and 52. In this case, the communication devices 51 and 52 and the variable links 70 and 71 (i.e., the communication resources) unnecessarily continue transmitting the data corresponding to 400 Mbps in total to the communication device 53 although the communication device 53 discards the data.

As described above, typical networks include communication resources (communication devices and links) that transmit data unnecessarily and hence have the problem of not necessarily utilizing communication resources efficiently.

In the network according to PTL 1, the band of a connected link is monitored to perform switching of links, but such a control as to prevent discarding of data in the entire network is not performed. For this reason, the network according to PTL 1 has the possibility that any of the communication devices in the network discards the data after the switching, and in the case where the data is discarded, corresponding communication resources sequentially transmit data to be discarded, unnecessarily, to the communication device (which discards the data).

Since the network according to PTL 1, as typical networks, includes communication resources (communication devices and links) that unnecessarily transmit data to be discarded, the network does not necessarily utilize communication resources efficiently.

The present invention aims to provide a communication device, a network, and a resource utilization method that solves the above-described problems.

### Solution to Problem

To achieve the above-described object, a communication device of the present invention is a communication device for which paths are set, and comprises: a detection means for outputting a first signal in response to a change in band of a link connected to a different one of the communication device for which the paths are set; and a change instruction means for determining, for each of the paths, a traffic rate so that a total traffic rate does not exceed the band of the link after the change, upon input of the first signal, and transmitting the determined traffic rate of the path to a communication device transmitting data on the path.

To achieve the above-described object, a communication device of the present invention is a communication device for which a path is set, and is configured to transmit data on the path at a traffic rate within a received traffic rate of the path.

To achieve the above-described object, the network according to the present invention includes a first communication device configured to transmit data on a set path and a second communication device configured to receive the data on the path. The second communication device is a communication device for which paths are set, and includes a communication device including: a detection means for outputting a first signal in response to a change in band of a link connected to a different communication device for which the paths are set; and a change instruction means for determining, for each of the paths, a traffic rate so that a total traffic rate does not exceed the band of the link after the change, upon input of the first signal, and transmitting the determined traffic rate of the path to a communication device transmitting the data on the path. The first communication device is a communication device for which paths are set, and includes a communication device configured to transmit the data on the path at a traffic rate within the received traffic rate of the path.

To achieve the above-described object, a resource utilization method of the present invention comprises: outputting a first signal in response to a change in band of a link for which one or more paths are set; determining, for each of the paths, a traffic rate so that a total traffic rate does not exceed the band after the change, upon input of the first signal, and outputting the determined traffic rate of the path; and transmitting data on the path at a traffic rate within the input traffic rate of the path.

### Advantageous Effects of the Invention

According to the present invention, the network is capable of efficiently utilizing the communication resources (the communication devices and the links) in the network, in comparison with typical networks.

### BRIEF DESCRIPTION OF DRAWINGS

FIG. 1 is a diagram illustrating an example of a configuration of a typical network.

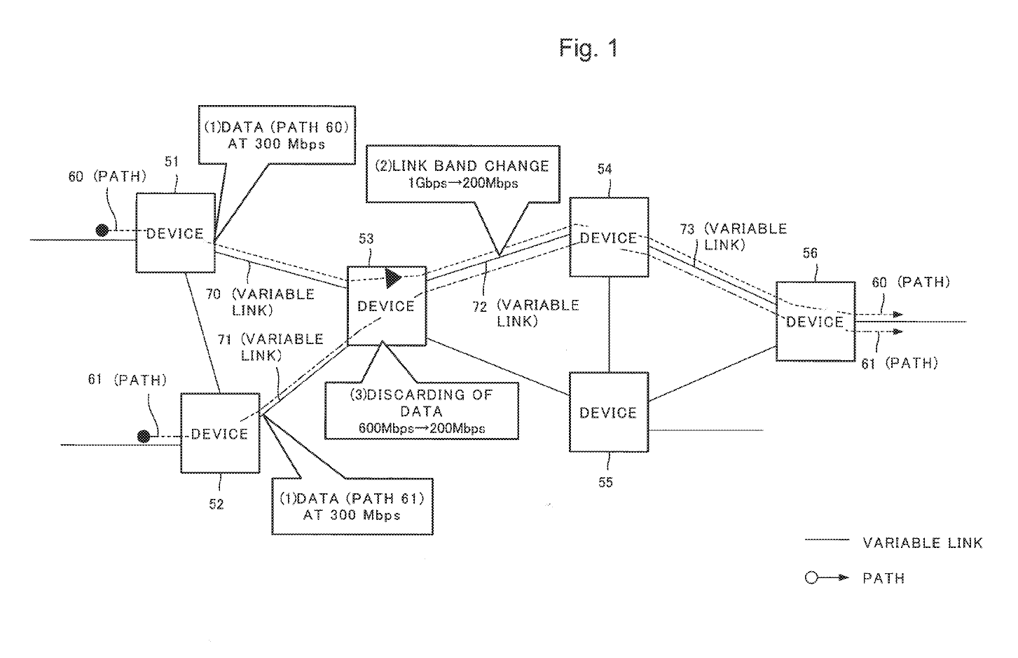

FIG. 2 is a diagram for describing an overview of a network according to a first exemplary embodiment of the present invention.

FIG. 3 is a diagram illustrating an example of a configuration of the network according to the first exemplary embodiment of the present invention.

FIG. 4 is a diagram illustrating an example of a configuration of a communication device 13 included in the network according to the first exemplary embodiment of the present invention.

FIG. 5 is a diagram illustrating an example of path information set for a communication device included in the network according to the first exemplary embodiment of the present invention.

FIG. 6 is a diagram illustrating an example of link information created by the communication device included in the network according to the first exemplary embodiment of the present invention.

FIG. 7 is a diagram for describing operations of the network (diagram illustrating a state of the network before the operations are performed) according to the first exemplary embodiment of the present invention.

FIG. 8 is a diagram for describing operations of the communication device 13 included in the network according to the first exemplary embodiment of the present invention.

FIG. 9 is a diagram for describing operations of a communication device 11 included in the network according to the first exemplary embodiment of the present invention.

FIG. 10 is a diagram for illustrating operations of a communication device 12 included in the network according to the first exemplary embodiment of the present invention.

FIG. 11 is a diagram for describing operations of the network (a diagram illustrating a state of the network after the operations are performed) according to the first exemplary embodiment of the present invention.

FIG. 12 is a diagram illustrating an example of a configuration of a network according to a second exemplary embodiment of the present invention.

### DESCRIPTION OF EMBODIMENTS

Next, exemplary embodiments of the present invention will be described in detail with reference to the drawings.

### First Exemplary Embodiment

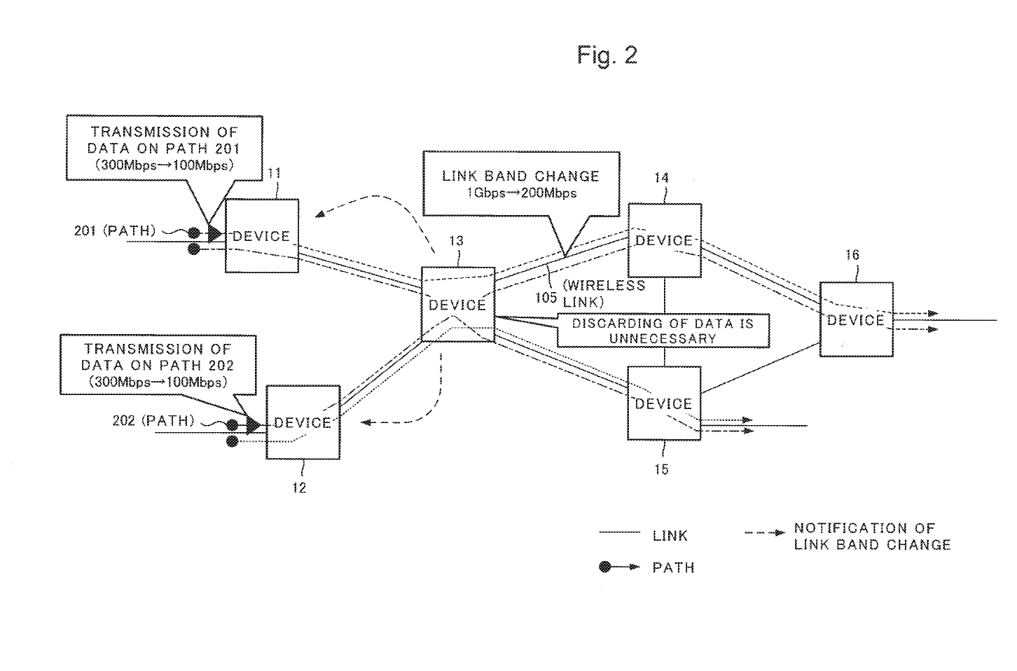

First, an overview of a network according to a first exemplary embodiment will be described. FIG. 2 is a diagram for illustrating an overview of the network according to the first exemplary embodiment of the present invention.

[Overview]

As illustrated in FIG. 2, paths 201 and 202 are set in the network according to this exemplary embodiment. A communication device 13 receives each of data on the path 201 (300 Mbps) transmitted from the communication device 11 and data on the path 202 (300 Mbps) transmitted from the communication device 12, and transmits the data to a wireless link 105. Upon decrease in band of the wireless link 105 (for example, from 1 Gbps to 200 Mbps), the communication device 13 determines, for each of the paths 201 and 202, a traffic rate (for example, 100 Mbps) so that the total traffic rate does not exceed the band of the wireless link 105, that is, 200 Mbps. The communication device 13 notifies the communication device 11, which is the data transmission source, of the determined traffic rate of the path 201, and the communication device 12, which is the data transmission source, of the determined traffic rate of the path 202. The communication device 11 transmits the data on the path 201 in a data rate reduced to the notified rate (100 Mbps), and the communication device 12 transmits the data on the path 202 in a data rate reduced to the notified rate (100 Mbps).

Consequently, in the network according to this exemplary embodiment, neither of the communication resources (the communication devices 11 and 12) unnecessarily transmits data to be discarded in the wireless link 105, and hence can use the processing capability for other processes. In other words, the network according to this exemplary embodiment can efficiently utilize the communication resources.

Detailed description will be given below of a configuration, functions, and operations of the network according to the first exemplary embodiment of the present invention.

[Description of Configuration]

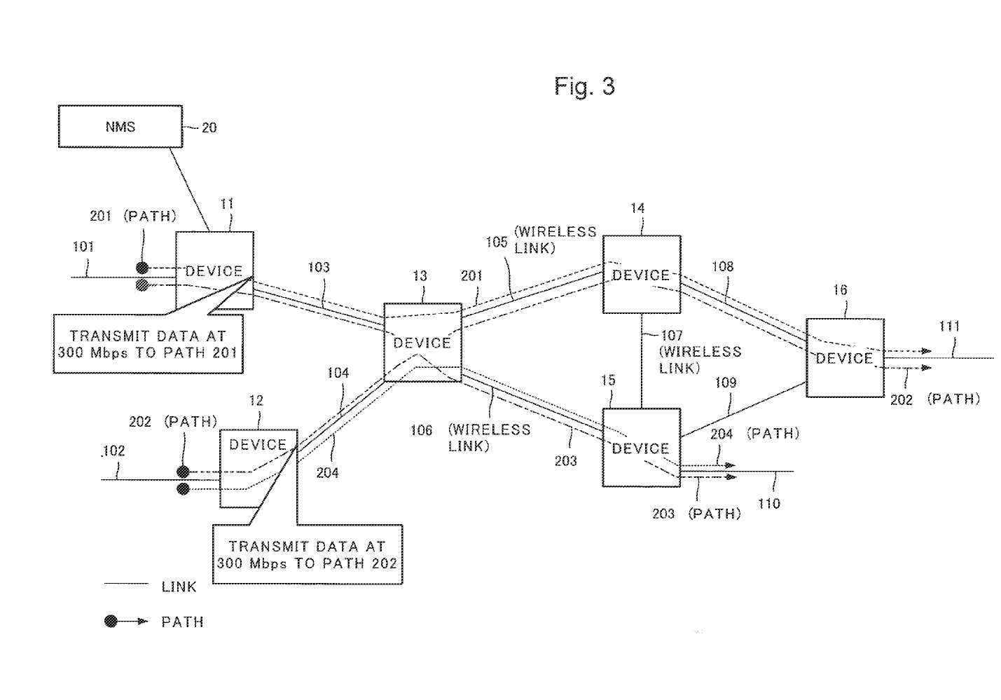

First, a configuration and functions of the network according to the first exemplary embodiment of the present invention will be described. FIG. 3 is a diagram illustrating an example of a configuration of the network according to the first exemplary embodiment of the present invention.

(1) Configuration of Network According to the First Exemplary Embodiment of the Present Invention

(1-1) Configuration of Network

The network according to this exemplary embodiment includes communication devices 11 to 16 as illustrated in FIG. 3.

The communication devices 11 to 16 are connected to each other via links 103 to 111. The links 105 to 107 are wireless channels (hereinafter each referred to as a “wireless link”). The other links 101 to 104 and 108 to 111 are wired channels.

The communication device 11 is connected to a network management system (NMS) 20. The communication devices 11, 12, and 16 are connected to devices (not depicted) provided outside the network via the links 101, 102, and 111, respectively.

(1-2) State of Network

In the network according to this exemplary embodiment, the paths 201 and 202 are set. As illustrated in FIG. 3, the path 201 is a path set for the communication device 11 as a start point, the link 103, the communication device 13, the wireless link 105, the communication device 14, the link 108, and the communication device 16. The path 202 is a path set for the communication device 12 as a start point, the link 104, the communication device 13, the wireless link 105, the communication device 14, the link 108, and the communication device 16. The communication device 11 transmits data to the path 201 at 300 Mbps, and the communication device 12 transmits data to the path 202 at 300 Mbps.

In addition, in the network according to this exemplary embodiment, paths 203 and 204 are also set. As illustrated in FIG. 3, the path 203 is a path set for the communication device 11 as a start point, the link 103, the communication device 13, the link 106, and the communication device 15. The path 204 is a path set for the communication device 12 as a start point, the link 104, the communication device 13, the link 106, and the communication device 15.

(2) Configurations of Communication Devices 11 to 16

(2-1) Configurations of Communication Devices 11 to 16

Next, description is given of configurations of the communication devices 11 to 16.

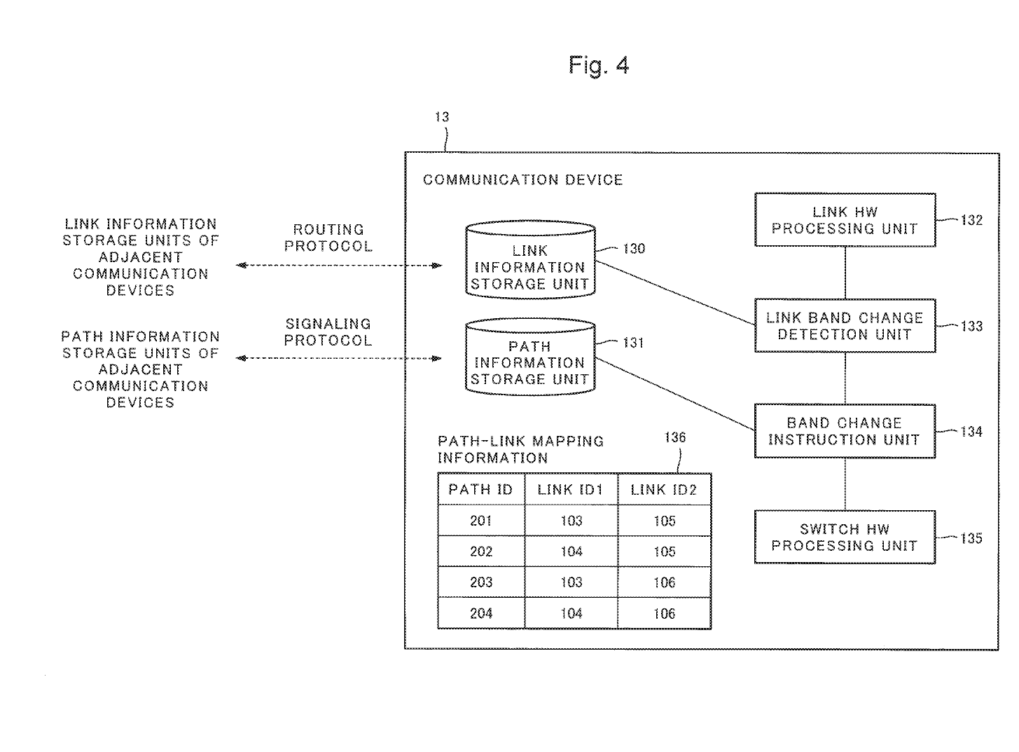

Since the communication devices 11 to 16 have the same configuration, description is given of the wireless communication device 13 as a representative. FIG. 4 is a diagram illustrating an example of a configuration of the communication device 13 included in the network according to the first exemplary embodiment of the present invention.

As illustrated in FIG. 4, the communication device 13 includes a link information storage unit 130, a path information storage unit 131, a link hardware (HW) processing unit 132, a link band change detection unit 133, a band change instruction unit 134, and a switch HW processing unit 135.

The link band change detection unit 133 is connected to the link information storage unit 130, the link HW processing unit 132, and the band change instruction unit 134. The band change instruction unit 134 is connected to the path information storage unit 131 and the switch HW processing unit 135.

Moreover, the link information storage unit 130 is connected to the link information storage units 110, 120, 140, and 150 of the respective adjacent communication devices 11, 12, 14, and 15. The link information storage units 110, 120, 140, and 150 are functional units having the same function as that of the link information storage unit 130.

Moreover, the path information storage unit 131 is connected to path information storage units 111, 121, 141, and 151 of the respective adjacent communication devices 11, 12, 14, and 15. The path information storage units 111, 121, 141, and 151 are functional units having the same function as the path information storage unit 131.

(2-2) Configuration Added to Communication Device 11

Although the communication devices 11 to 16 have the same configuration, the path information storage unit 111 of the communication device 11 is connected to the NMS 20.

(2-3) Method of Implementing Functional Units of Communication Devices 11 to 16, and Others

Each of the functional units 130 to 135 can be implemented by using an electronic circuit or a field-programmable gate array (FPGA). Each of the functional units 130 to 135 includes a memory, such as a random access memory (RAM).

(3) Functions of Communication Devices 11 to 16

(3-1) Functions of Main Bodies of Communication Devices 11 to 16

Each of the communication devices 11 to 16 has the function of performing wireless communications with the adjacent ones of the communication devices 11 to 16 by using a known adaptive modulation technique, as with typical communication devices. Specifically, each of the communication devices 11 to 16 obtains a data rate of data received from each of the adjacent ones of the communication devices 11 to 16 for every certain period and notifies the adjacent ones of the communication devices 11 to 16 of the coding scheme corresponding to the data rate. The coding scheme corresponding to the data rate is set in advance for each of the communication devices 11 to 16 by the manager of the network according to this exemplary embodiment. When each of the communication devices 11 to 16 is notified of the coding scheme from the adjacent one of the communication devices 11 to 16, the communication device performs wireless communications with the adjacent one of the communication devices 11 to 16 by using the coding scheme.

(3-2) Functions of Functional Units Configuring Each of Communication Devices 11 to 16

Description is given of functions of the functional units configuring each of the communication devices 11 to 16. Since the functions of the functional units are all the same among the communication devices 11 to 16, description is given of the functional units of the communication device 13 as a representative.

(3-2-1) Function of Path Information Storage Unit 131

(3-2-1-1) Setting of Path Information and Path-Link Mapping Information

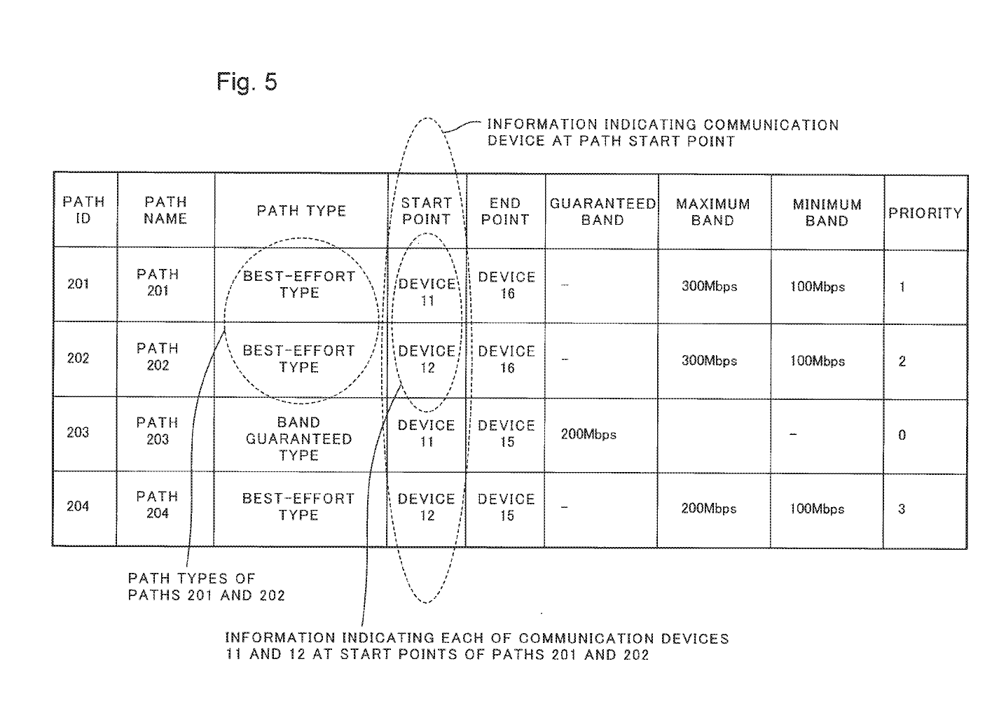

First, path information and path-link mapping information are set in the path information storage unit 131 by the NMS 20. FIG. 5 is a diagram illustrating an example of path information set in each communication device included in the network according to the first exemplary embodiment of the present invention.

(3-2-1-1-1) Regarding Path Information

Path information is a table in which, for each path set in the network, pieces of information indicating the path ID indicating the path, the path name, the path type, and the communication device at the start point of the path, and the like are associated with each other, as illustrated in FIG. 5.

The above-mentioned path type is information defining the type of data to be transmitted via the path, i.e., best-effort type or band guaranteed type. When the path type is the band guaranteed type, the band that is to be guaranteed (hereinafter referred to as a “guaranteed band”), 200 Mbps, is also associated with the path type, as illustrated in FIG. 5. The information indicating the communication device at the path start point may be the IP address of the communication device at the path start point.

(3-2-1-1-2) Regarding Path-Link Mapping Information

The path-link mapping information is a table indicating the path set for each link connected to the communication device holding the path-link mapping information.

For example, in path-link mapping information 136 illustrated in FIG. 4, path ID 201 and link IDs 103 and 105 are associated to each other, and this association indicates that the path 201 is set for the links 103 and 105 connected to the communication device 13 holding the path-link mapping information 136. Path ID 201 is an identification (ID) indicating the path 201, and the link IDs 103 and 105 are IDs respectively indicating the links 103 and 105.

In the path-link mapping information 136 in FIG. 4, link ID 1 and link ID 2 are included as link IDs. The link ID 1 is a link ID indicating the link through which data is input to the communication device 13, and the link ID 2 is a link ID indicating the link through which the communication device 13 outputs data.

Note that, an identifier indicating the communication device is assigned to the path-link mapping information so as to recognize which communication device relates to the path-link mapping information.

Although the description of the functions of each functional unit configuring the communication devices 11 to 16 will be continued below, the following description of the functions may alternatively be read after reading [Description of Operations] to be described later.

(3-2-1-2) Extraction and Transmission Function (Function of Path Information Storage Unit 131)

Upon input of a path ID, the path information storage unit 131 extracts and outputs information associated with the input path ID, specifically, information indicating the communication device at the start point of the corresponding path, from the path information (set in the path information storage unit 131 itself).

Moreover, upon input of a signal for requesting acquisition of path-link mapping information, the path information storage unit 131 outputs the path-link mapping information 136 set in the path information storage unit 131.

(3-2-1-3) Transfer Function (Function of Path Information Storage Unit 131)

In (3-2-1-1) Above, it is Described that “Path Information and path-link mapping information are set by the NMS 20”. However, the path information storage unit 131 is not directly connected to the NMS 20. The path information storage unit 131 is connected to the NMS 20 via the path information storage unit 111 of the adjacent communication device 11.

The path information storage unit 131 has a transfer function of setting, upon input of path information and path-link mapping information, the information in the path information storage unit 131 itself and transferring the information to the path information storage unit of each adjacent communication device in accordance with a known signaling protocol.

When the above-described transfer function operates, the path information and the path-link mapping information is set in the path information storage unit 131 by the NMS 20 as will be described in “(3-2-1-3-1)” below.

(3-2-1-3-1) Regarding Setting of Path Information and Others by NMS 20

First, path information and path-link mapping information is set (input) to the path information storage unit 111 of the communication device 11 by the NMS 20. Since the path information storage unit 111 has the same function as that of the path information storage unit 131, the path information storage unit 111 transfers the input path information and path-link mapping information to the path information storage unit 131 of the adjacent communication device 13. The path information storage unit 131 sets the path information and the path-link mapping information transferred from the path information storage unit 111, in the path information storage unit 131 itself. In other words, the path information and the path-link mapping information is set in the path information storage unit 131 by the NMS 20 (via the path information storage unit 111).

When the path information storage unit 131 sets path-link mapping information in the path information storage unit 131 itself, the path information storage unit 131 sets path-link mapping information to which an identifier indicating the communication device 13 including the path information storage unit 131 itself is assigned.

The above-described known signaling protocol may be RSVP-TE or CR-LDP. RSVP-TE is an abbreviation of Reservation Protocol extended for Traffic Rngineering. CR-LDP is an abbreviation of Constraint based Routing Label Distribution Protocol.

(3-2-2) Function of Link HW Processing Unit 132

(3-2-2-1) Band Monitoring Function (Function of Link HW Processing Unit 132)

The link HW processing unit 132 monitors, for each link connected to the communication device 13, whether there is any change in band. Specifically, the link HW processing unit 132 monitors whether there is a change of the coding scheme that is notified (to the main body of the communication device 13 from any adjacent communication device) by using a known adaptive modulation technique.

(3-2-2-2) Function of Notifying Band that has Changed (Function of Link HW Processing Unit 132)

When there is a change in band, that is, when there is a change of the notified coding scheme, the link HW processing unit 132 calculates a data rate that can be transmitted in the coding scheme that has changed (hereinafter referred to as a “band after the change”). A correspondence table in which the coding scheme and the data rate that can be transmitted in the coding scheme are associated with each other is set in the link HW processing unit 132 by the manager of the network according to this exemplary embodiment. The link HW processing unit 132 calculates a band after the change from the above-described correspondence table. Specifically, the link HW processing unit 132 acquires the data rate corresponding to the coding scheme that has changed and that can be transmitted in the coding scheme (i.e., the band after the change) from the correspondence table.

The link HW processing unit 132 includes the acquired band after the change and the link ID indicating the link the band of which has changed, in a signal indicating that the band has changed (hereinafter referred to as a “band change notification signal”), and outputs the signal to the link band change detection unit 133. A link ID corresponding to each link connected to the communication device 13 is set in advance in the link HW processing unit 132 by the manager of the network according to this exemplary embodiment.

(3-2-3) Function of Link Band Change Detection Unit 133

Upon input of the above-described band change notification signal, the link band change detection unit 133 extracts the link ID and the band after the change, from the signal. After extracting the link ID and the band after the change, the link band change detection unit 133 includes the extracted link ID and band after the change in a signal for requesting update of the link information, and outputs the signal to the link information storage unit 130.

After outputting the signal for requesting update of the link information, the link band change detection unit 133 includes the extracted link ID and band after the change in a signal for requesting band calculation, and outputs the signal to the band change instruction unit 134.

(3-2-4) Function of Link Information Storage Unit 130

(3-2-4-1) Function of Reflection in Link Information

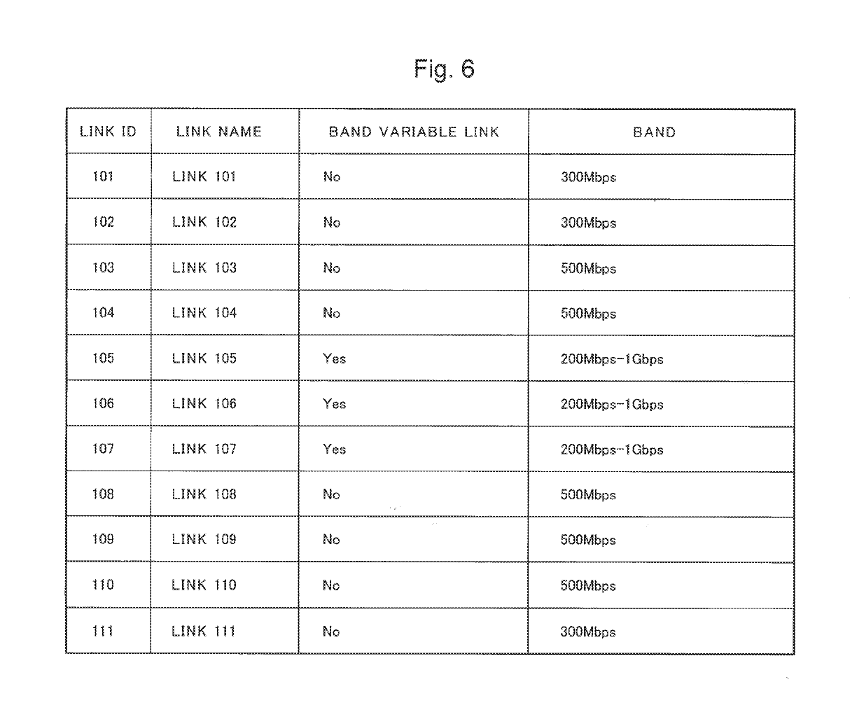

Upon input of the signal for requesting update of the link information, the link information storage unit 130 extracts the link ID and the band after the change from the signal. The link information storage unit 130 reflects the extracted link ID and band after the change in the link information. As illustrated in FIG. 6, the link information is a table indicating the band of each link in the network, and the link ID of each link and the band of the link are associated with each other in the table.

The link information storage unit 130 updates the band related to the extracted link ID to the (extracted) band after the change in the link information, to thereby reflect the band after the change in the link information. When the extracted link ID is not included in the link information, the link information storage unit 130 adds the extracted link ID and band after the change, in an associated manner, to the link information.

(3-2-4-2) Link Information Exchange Function

The link information storage unit 130 may also exchange the link information with each of the link information storage units 110, 120, 140, and 150 of the adjacent communication devices 11, 12, 14, and 15 by using a known routing protocol. The link information storage unit 130 may reflect the link IDs and bands in the exchanged link information, in the holding link information. Specifically, the link information storage unit 130 overwrites the information (link IDs and bands) in the holding link information with the link IDs and bands in the exchanged link information. Note that, however, the link information storage unit 130 neither overwrites nor updates the link information of the communication device 13 itself (the reflected bands described above in (3-2-4-1)).

The known routing protocol mentioned above may be OSPF-TE or the like. OSPF-TE is an abbreviation of Open Shortest Path First extended for Traffic Engineering.

(3-2-5) Function of Band Change Instruction Unit 134

(3-2-5-1) Function of Calculating Traffic Rate to be Reduced

Upon input of the signal for requesting band calculation from the link band change detection unit 133, the band change instruction unit 134 extracts the link ID and the band after the change from the signal. The extracted link ID is the ID indicating the link the band of which has changed.

After extracting the link ID and the band after the change, the band change instruction unit 134 acquires the path-link mapping information 136 from the path information storage unit 131.

The band change instruction unit 134 extracts path IDs related to the extracted link ID from the acquired path-link mapping information 136.

The band change instruction unit 134 calculates, for each extracted path ID, traffic rate (communication rate) that does not exceed the extracted band (band after the change) and stores the path ID and the calculated traffic rate in an associated manner. A method of calculating traffic rate will be described in detail in [Description of Operations] to be described later.

(3-2-5-2) Function of Notifying Communication Device at Path Start Point of Traffic Rate to be Reduced

The band change instruction unit 134 transmits each path ID and the traffic rate stored in the associated manner in (3-2-5-1) above, to (the band change instruction unit of) the communication device at the start point of the path indicated by the path ID.

(3-2-5-3) Function of Band Change Instruction Unit 134 as Communication Device at Path Start Point

Upon receipt of a traffic rate and a path ID from the band change instruction unit of a different communication device, the band change instruction unit 134 outputs the received traffic rate and path ID to the switch HW processing unit 135 and the path information storage unit 131. The band change instruction unit 134 may convert the received traffic rate and path ID to an electric signal and output the electric signal.

(3-2-6) Function of Switch HW Processing Unit 135

Upon receipt of the traffic rate and the path ID from the band change instruction unit 134, the switch HW processing unit 135 transmits the data on the path indicated by the received path ID at the traffic rate reduced to the received traffic rate (communication rate). The above-mentioned data on the path indicated by the path ID may be set by the manager of the network according to this exemplary embodiment or may be set, if there is a device connected to the switch HW processing unit 135, from the device.

(4) Function of NMS 20

The NMS 20, as with typical network management systems (NMSs), has a typical path setting function and sets paths between the communication devices 11 to 16 of the network according to this exemplary embodiment.

In addition, the NMS 20, as with typical NMSs, has a path management function and generates path information and path-link mapping information described above. The NMS 20 outputs path information and path-link mapping information described above to the path information storage unit 111 of the communication device 11 for every certain period. The certain period may be set in the NMS 20 by the manager of the network according to this exemplary embodiment.

[Description of Operations]

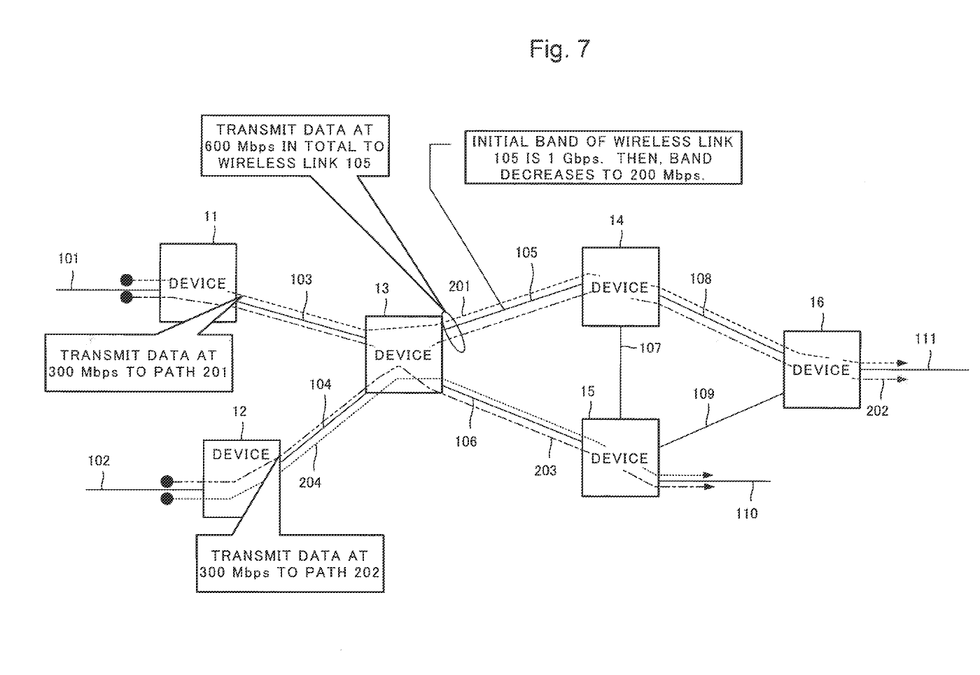

Operations of the network according to this exemplary embodiment will be described below with reference to FIG. 7 to FIG. 11.

In the following, description is given by taking, as an example, a case in which the communication device 11 transmits data at 300 Mbps to the path 201, the communication device 12 transmits data at 300 Mbps to the path 202, and the communication device 13 transmits the data corresponding to 600 Mbps in total received from the communication devices 11 and 12, to the wireless link 105, as illustrated in FIG. 7. Here, the band of the wireless link 105 is 1 Gbps.

Assume that the band of the wireless link 105 decreases from 1 Gbps to 200 Mbps in the above-described case.

Operations of the network according to this exemplary embodiment in this case will be described.

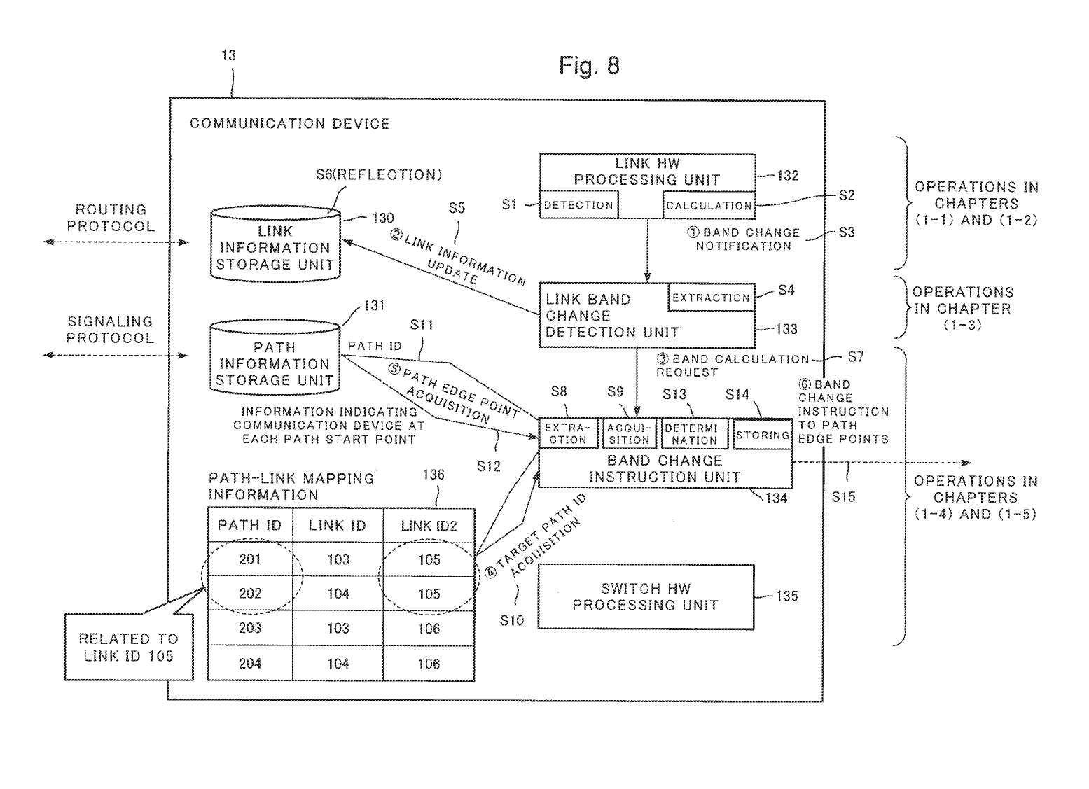

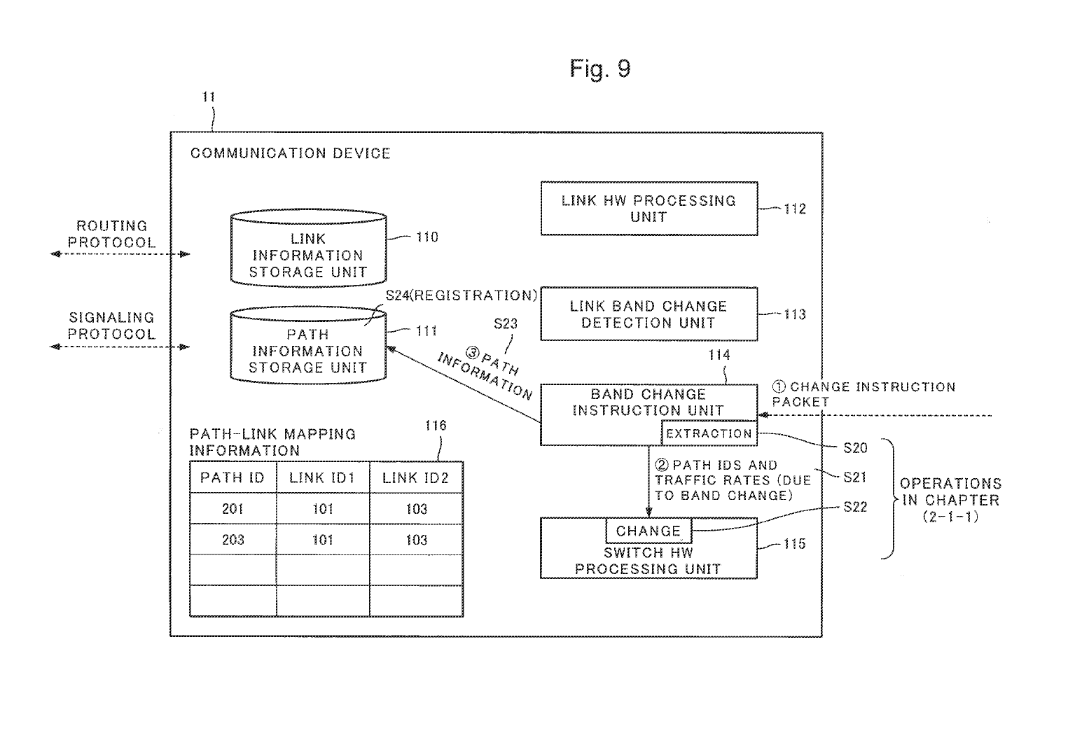

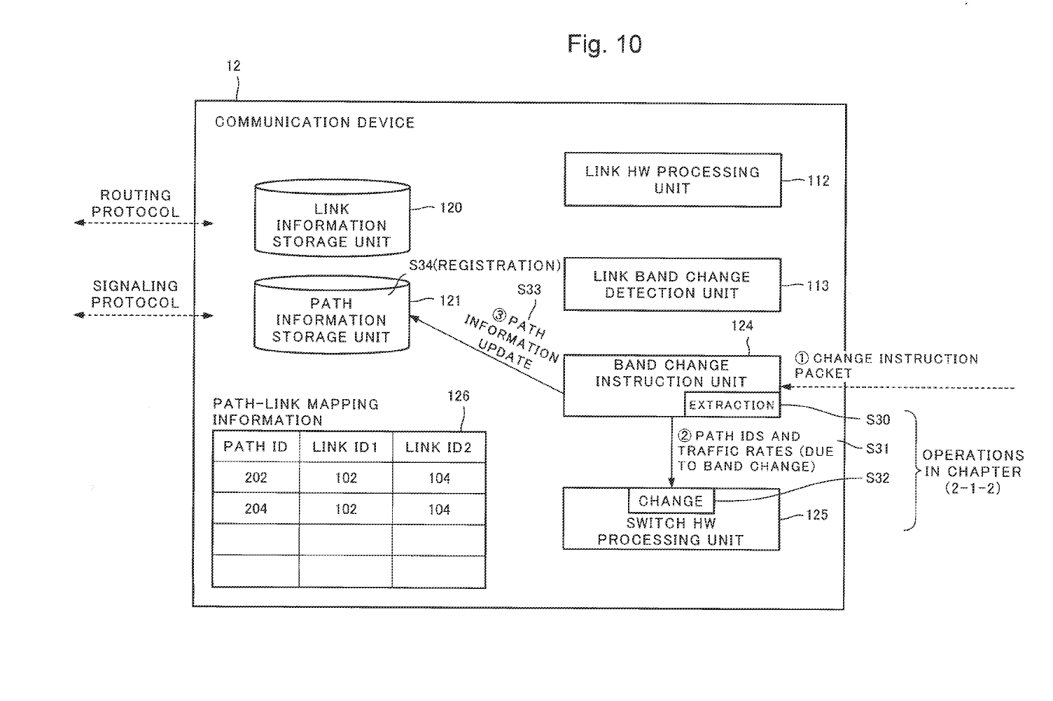

It is also assumed that the path information illustrated in FIG. 5 is already set in the path information storage unit of each of the communication devices 11 to 16 by the NMS 20. In addition, it is assumed that the path-link mapping information 136 illustrated in FIG. 8 is already set in the path information storage unit 131 of the communication device 13, the path-link mapping information 116 illustrated in FIG. 9 is already set in the path information storage unit 111 of the communication device 11, the path-link mapping information 126 illustrated in FIG. 10 is already set in the path information storage unit 121 of the communication device 12, by the NMS 20.

(1) Operations of Communication Device 13 When Band of Wireless Link has Changed

(1-1) Detection of Wireless Link 105 Band of which has Changed

First, when the band of the wireless link 105 decreases to 200 Mbps, the link HW processing unit 132 of the communication device 13 detects that the band of the wireless link 105 has changed, as illustrated in FIG. 8 (S1).

Specifically, the link HW processing unit 132 monitors whether there is a change of the coding scheme notified (to the communication device 13 main body) from the adjacent communication device 14, by using a known adaptive modulation technique, and detects that the coding scheme has changed.

(1-2) Calculation of Band (Data Rate that can be Transmitted in Wireless Link 105) after Change

When a change in band is detected, that is, when a change of the coding scheme is detected, the link HW processing unit 132 of the communication device 13 calculates a data rate that can be transmitted in the coding scheme after the change (hereinafter referred to as a “band after the change”) (S2).

A correspondence table in which each coding scheme and the data rate that can be transmitted in the coding scheme are associated with each other, is set in the link HW processing unit 132 by the manager of the network according to this exemplary embodiment. The link HW processing unit 132 calculates a band after the change corresponding to the notified coding scheme, from the correspondence table.

The description will be continued below by assuming that the link HW processing unit 132 has obtained 200 Mbps as the band after the change through the calculation.

The link HW processing unit 132 then outputs a signal indicating that the band has changed (i.e., a band change notification signal) to the link band change detection unit 133 (S3).

In this operation, the link HW processing unit 132 includes link ID 105 indicating the link 105 the band of which has changed and the band after the change, that is, 200 Mbps, in the band change notification signal, and outputs the band change notification signal.

(1-3) Reflection of Band after Change in Link Information

(1-3-1) Overview of Operations

The communication device 13 reflects the band after the change of the wireless link 105, that is, 200 Mbps, in the link information stored in the link information storage unit 130. The link information is the summary of the bands of the respective links in the network connecting the communication devices 11 to 16 to each other as illustrated in FIG. 6, and in the link information, the link ID indicating each link and the band of the link are associated with each other.

To perform the above-described operations, the respective units of the communication device 13 operate as will be described in “(1-3-2) Details of Operations” below.

(1-3-2) Details of Operations

First, upon input of the above-described band change notification signal, the link band change detection unit 133 extracts link ID 105 and the band after the change (200 Mbps) from the signal (S4).

The link band change detection unit 133 then includes the extracted link ID 105 and band after the change (200 Mbps) in a signal for requesting link information update, and outputs the signal to the link information storage unit 130 (S5).

Upon input of the signal for requesting link information update, the link information storage unit 130 extracts link ID 105 and the band after the change from the signal and reflects link ID 105 and the band after the change (200 Mbps), which are extracted, in the link information (S6).

Specifically, the link information storage unit 130 updates the band related to extracted link ID 105 to the (extracted) band after the change (200 Mbps) in the link information illustrated in FIG. 6. When the extracted link ID 105 is not included in the link information, the link information storage unit 130 adds, to the link information, link ID 105 and the band after the change (200 Mbps) thus extracted, in an associated manner.

After S6 described above, the link information storage unit 130 may exchange the link information with each of the link information storage units 110, 120, 140, and 150 of the adjacent communication devices 11, 12, 14, and 15 by using the link information exchange function described in “(3-2-4-2)” above. Thereby, the link information storage units of the communication devices 11 to 16 have the same link information in common. Consequently, the manager of the network according to the present exemplary embodiment can grasp the bands of the respective links in the network by reading the link information from the link information storage unit of a neighboring one of the communication devices.

(1-4) Determination of Traffic Rate to be Reduced and Transmission to Communication Device at Path Start Point

(1-4-1) Overview of Operations

The communication device 13 then determines a traffic rate for each of the paths 201 and 202 set in the wireless link 105 that has changed so that the total traffic rate does not exceed the band after the change of the wireless link 105 (200 Mbps). For example, the communication device 13 may determine the traffic rate of the path 201 to be 100 Mbps and the traffic rate of the path 202 to be 100 Mbps.

To perform the above-described operations, the respective units of the communication device 13 operate as will be described in “(1-4-2) Details of Operations” below.

(1-4-2) Details of Operations

(1-4-2-1) Acquisition of Path ID of Each Path Set in Wireless Link 105 Band of which has Changed

After S5 described above, first, the link band change detection unit 133 of the communication device 13 includes the band after the change (200 Mbps) and link ID 105, which are extracted (in S4 above), in a signal for requesting band calculation and outputs the signal to the band change instruction unit 134 (S7).

Upon input of the signal for requesting band calculation from the link band change detection unit 133, the band change instruction unit 134 extracts link ID 105 and the band after the change (200 Mbps) from the signal (S8).

Next, after extracting link ID 105 and the band, that is, 200 Mbps, the band change instruction unit 134 acquires the path-link mapping information 136 from the path information storage unit 131 (S9).

Specifically, the band change instruction unit 134 outputs a signal for requesting acquisition of the path-link mapping information (hereinafter referred to as a “mapping information request signal”) to the path information storage unit 131. Upon input of the mapping information request signal, the path information storage unit 131 transmits the path-link mapping information 136 set in the path information storage unit 131 itself, to the band change instruction unit 134. The band change instruction unit 134 receives and acquires the path-link mapping information 136.

After acquiring the path-link mapping information 136, the band change instruction unit 134 then acquires path IDs 201 and 202 related to link ID 105 extracted in S8 described above, from the path-link mapping information 136 (S10).

In this operation, the band change instruction unit 134 acquires path IDs 201 and 202 related to the link 105 as illustrated in FIG. 8.

(1-4-2-2) Acquisition of Information Related to Each of Path IDs 201 and 202 (Acquisition of Information Indicating Each of Communication Devices 11 and 12 at Start Points of Paths 201 and 202, and Others)

The band change instruction unit 134 subsequently outputs path IDs 201 and 202 acquired in S10, to the path information storage unit 131 (S11). This is to acquire information related to each of path IDs 201 and 202 (e.g., information indicating each of the communication devices 11 and 12 respectively at the start points of the paths 201 and 202) from the path information illustrated in FIG. 5.

The information related to path ID 201 includes the information indicating the communication device 11 at the start point of the path 201 (specifically, the IP address of the communication device 11), the path type of the path 201, and the priority of the path 201, in the path information, and the information related to path ID 202 includes the information indicating the communication device 12 at the start point of the path 202 (specifically, the IP address of the communication device 12), the path type of the path 202, and the priority of the path 202, in the path information. When the path type of each of the paths 201 and 202 is the band guaranteed type, the above-described information related to the corresponding one of path IDs 201 and 202 also includes the band that is to be guaranteed (hereinafter referred to as a “guaranteed band”), that is, 200 Mbps.

Upon input of path IDs 201 and 202, the path information storage unit 131 acquires the information related to each of input path IDs 201 and 202 from the path information and outputs the information to the band change instruction unit 134 (S12).

(1-4-2-3) Determination of Traffic Rate to be Reduced for Each of Paths 201 and 202

Upon input of information related to path ID 201 and information related to path ID 202, the band change instruction unit 134 determines, for each of path IDs 201 and 202, a traffic rate so that the total traffic rate does not exceed the band of the wireless link 105, that is, 200 Mbps (extracted in S8 described above) (S13).

For example, the band change instruction unit 134 may determine the traffic rate of path ID 201 to be 100 Mbps and the traffic rate of path ID 202 to be 100 Mbps, in consideration that each traffic rate may be any as long as the total traffic rate does not exceed the band, 200 Mbps.

Alternatively, the band change instruction unit 134 may extract the path type, the guaranteed band, and the priority of each of path IDs 201 and 202 from the information related to input path IDs 201 and 202, and determine the traffic rate of each of path IDs on the basis of the extracted path type, guaranteed band, and priority.

For example, when the extracted path types of path IDs 201 and 202 are both the best-effort type, the band change instruction unit 134 may determine the traffic rates of path IDs 201 and 202 to be equal (both traffic rates to be 100 Mbps) as described above.

When the extracted path type of path ID 201 is the band guaranteed type and the extracted path type of path ID 202 is the best-effort type, the band change instruction unit 134 may determine the traffic rate for path ID 201 of the band guaranteed type to be the above-described guaranteed band, that is, 200 Mbps. In this case, in order that the total traffic rate does not exceed the band, that is, 200 Mbps extracted in S8 described above, the band change instruction unit 134 determines the traffic rate of path ID 202 of the best-effort type to be 0 Mbps (=the band of the wireless link 105, that is, 200 Mbps, extracted in S8 described above—guaranteed band).

Further, when the path types of path IDs 201 and 202 are both the same band guaranteed type, the band change instruction unit 134 may determine the traffic rate of each path in consideration of priority.

For example, the band change instruction unit 134 may determine the traffic rate of the path ID corresponding to a higher priority to be the guaranteed band and the traffic rate of the path ID corresponding to a lower priority to be (the band of the wireless link 105, that is, 200 Mbps, extracted in S8 described above—guaranteed band).

After determining the traffic rate for each path ID in S13 described above, the band change instruction unit 134 stores the determined traffic rate and path ID in an associated manner (S14).

The description will be continued below by assuming that the band change instruction unit 134 has determined the traffic rate for path ID 201 to be 100 Mbps and the traffic rate for path ID 202 to be 100 Mbps, and has stored each path ID and the corresponding traffic rate in an associated manner.

(1-5) Notification of each Determined Traffic Rate to Communication Device at Path Start Point

(1-5-1) Overview of Operations

The communication device 13 then instructs each of the communication devices 11 and 12 at the start points of the paths 201 and 202 to transmit data at the determined traffic rate, that is, 100 Mbps (i.e., the band of 100 Mbps).

To perform the above-described operations, the respective units of the communication device 13 operate as will be described in “(1-5-2) Details of Operations” below.

(1-5-2) Details of Operations

First, the band change instruction unit 134 of the communication device 13 transmits each path ID and the corresponding traffic rate stored in S14 to the band change instruction unit of the communication device at the start point of the path indicated by the path ID (S15).

Specifically, the band change instruction unit 134 transmits path ID 201 and the traffic rate, that is, 100 Mbps, as a packet (hereinafter referred to as a “change instruction packet”) to the band change instruction unit 114 of the communication device 11 at the start point of the path 201. The destination IP address of the change instruction packet is the IP address of the communication device 11. The IP address of the communication device 11 is included in the information related to path ID 201 input in S12.

Similarly, the band change instruction unit 134 transmits path ID 202 and the traffic rate, that is, 100 Mbps, as a packet to the band change instruction unit 124 of the communication device 12 at the start point of the path 202.

(2) Operations of each of Communication Devices 11 and 12 at Path Start Points to Transmit Data at Determined Traffic Rate

(2-1) Overview of Operations

Upon receipt of the traffic rate, that is, 100 Mbps, from the communication device 13, the communication device 11 at the start point of the path 201 transmits the data on the path 201 at a traffic rate within the received traffic rate (band), and the communication device 12 at the start point of the path 202 transmits the data on the path 202 at a traffic rate within the received traffic rate (band).

The respective units of the communication devices 11 and 12 operate as will be described in (2-1-1) and (2-1-2) below. (2-1-1) below describes the operations of the respective units of the communication device 11, and (2-1-2) below describes the operations of the respective units of the communication device 12. FIG. 9 and FIG. 10 are diagrams for illustrating the operations of the communication devices 11 and 12 included in the network according to the first exemplary embodiment of the present invention.

(2-1-1) Details of Operations (Operations of Communication Device 11 at Start Point of Path 201)

First, upon receipt of the change instruction packet in which the destination IP address is the IP address of the communication device 11, the band change instruction unit 114 of the communication device 11 extracts path ID 201 and the traffic rate, that is, 100 Mbps, from the packet (S20).

The band change instruction unit 114 then outputs path ID 201 and the traffic rate, that is, 100 Mbps, which are thus extracted, to the switch HW processing unit 115 (S21).

Upon receipt of path ID 201 and the traffic rate, that is, 100 Mbps, the switch HW processing unit 115 transmits the data on the path 201 indicated by path ID 201, which is transmitted at 300 Mbps, at the traffic rate reduced to the received traffic rate (100 Mbps) (S22).

For example, when the data on the path 201 is set in advance in the switch HW processing unit 115 by a device (not illustrated) outside the network, and the switch HW processing unit 115 has been transmitting the data on the path 201 at the amount corresponding to 300 Mbps, the switch HW processing unit 115 may transmit the data at the amount corresponding to the traffic rate (100 Mbps).

After S21 described above, the band change instruction unit 114 of the communication device 11 may output path ID 201 and the traffic rate, that is, 100 Mbps, which are extracted in S20, to the path information storage unit 111 (S23).

In this case, upon input of path ID 201 and the traffic rate, 100 Mbps, the path information storage unit 111 may register the input traffic rate, that is, 100 Mbps, in the path information as the current traffic rate (S24). In this operation, the path information storage unit 111 registers the input traffic rate, that is, 100 Mbps, in association with path ID 201 in the path information.

The manager of the network according to the present exemplary embodiment acquires the path information registered in the path information storage unit 111, so that the manager can check the current traffic rate of the path 201, that is, 100 Mbps.

(2-1-2) Details of Operations (Operations of Communication Device 12 at Start Point of Path 201)

The communication device 12 performs exactly the same operations as those of the communication device 11. Hence, the following description is the same as that in (2-1-1) above.

First, upon receipt of a change instruction packet in which the destination IP address is the IP address of the communication device 12, the band change instruction unit 124 of the communication device 12 extracts path ID 202 and the traffic rate, that is, 100 Mbps, from the packet (S30), as described in FIG. 10.

The band change instruction unit 124 then outputs path ID 202 and the traffic rate, that is, 100 Mbps, which are thus extracted, to the switch HW processing unit 125 (S31).

Upon receipt of path ID 202 and the traffic rate, that is, 100 Mbps, the switch HW processing unit 125 transmits the data on the path 202 indicated by path ID 202, which is transmitted at 300 Mbps, at the traffic rate reduced to the received traffic rate (100 Mbps) (S32).

For example, when the data on the path 202 may be set in advance in the switch HW processing unit 125 by a device (not illustrated) outside the network, and the switch HW processing unit 125 transmits the data on the path 202 at the amount corresponding to 300 Mbps, the switch HW processing unit 125 may transmit the data at the amount corresponding to the traffic rate (100 Mbps).

After S31 described above, the band change instruction unit 124 of the communication device 12 may output path ID 202 and the traffic rate, that is, 100 Mbps, which are extracted in S30, to the path information storage unit 121 (S33).

In this case, upon input of path ID 202 and the traffic rate, that is, 100 Mbps, the path information storage unit 121 may register the input traffic rate, 100 Mbps, in the path information as the current traffic rate (S34). In this operation, the path information storage unit 121 registers the input traffic rate, that is, 100 Mbps, in association with path ID 202 in the path information.

The manager of the network according to the present exemplary embodiment acquires the path information registered in the path information storage unit 121, so that the manager can check the current traffic rate of the path 202, that is, 100 Mbps.

(3) Summary of Operations in S1 to S34 Above

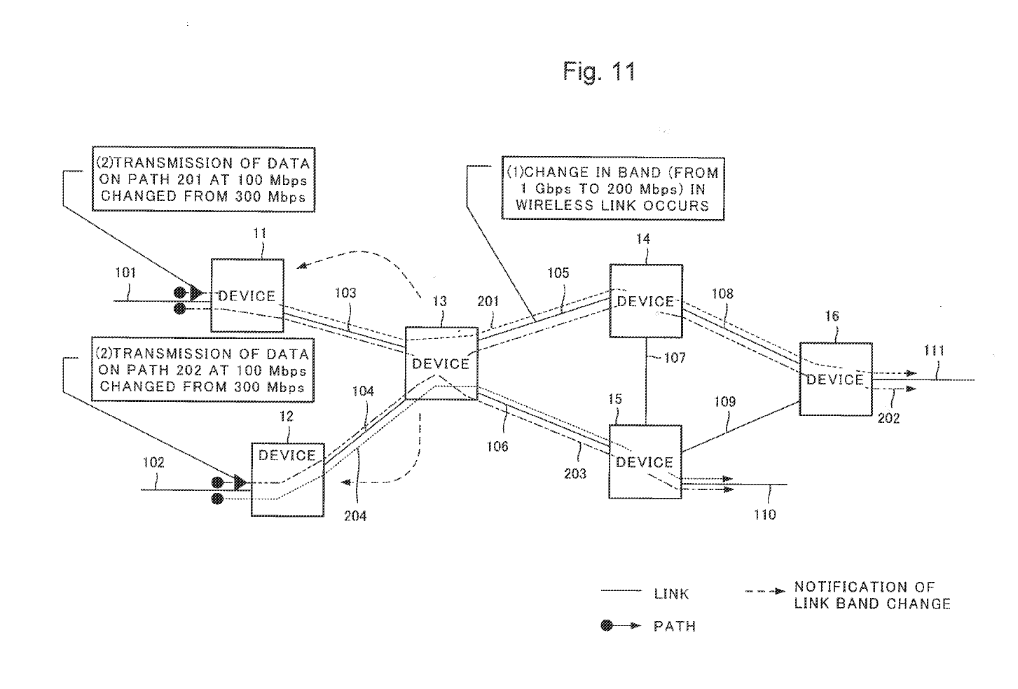

FIG. 11 is a diagram illustrating the state of the network after 51 to S34 above are performed.

As a result of S1 to S34 above being performed, the communication device 11 transmits data on the path 201 at the traffic rate reduced to 100 Mbps from 300 Mbps, and the communication device 12 transmits data on the path 202 at the traffic rate reduced from 300 Mbps to 100 Mbps. In other words, the communication devices 11 and 12 do not unnecessarily transmit data to be discarded in the wireless link 105. Consequently, the communication devices 11 and 12, which do not unnecessarily transmit data to be discarded, can use the processing capability for other processes. Further, the links 103 and 104 do not unnecessarily transmit data to be discarded and can hence transmit data on other paths. In other words, the network according to the present exemplary embodiment does not include any communication resources (communication devices and links) that unnecessarily transmit data to be discarded, which makes it possible to utilize the communication resources thus saved for other processes. To be more precise, the network according to the present exemplary embodiment can more efficiently utilize the communication resources (communication devices and links) in the network.

(4) Case in which Wireless Link 105 Returns to 1 Gbps from 200 Mbps

When the wireless link 105 returns to 1 Gbps from 200 Mbps, the link HW processing unit 132 detects that the band of the wireless link 105 has changed, and consequently S1 to S32 above are performed again. As a result, the communication device 11 can transmit the data on the path 201 at the traffic rate of 300 Mbps again, and the communication device 12 can transmit the data on the path 202 at the traffic rate of 300 Mbps again.

(5) Regarding Communication Device Configured to Monitor Wireless Link

In the above description, the link HW processing unit 132 of the communication device 13 detects a change in band of the wireless link 105. However, the link HW processing unit 142 of the communication device 14 may detect a change in band of the wireless link 105.

In this case, the link HW processing unit 142 of the communication device 14 monitors whether there is a change of the modulation scheme (used to modulate the data in the link 105 by the communication device 13 main body) notified from the communication device 13 main body by using a known adaptive modulation technique in S1 described above. (This modulation scheme is used to decode the data in the link 105 in the communication device 14.) Upon detection of a change of the above-described modulation scheme, the link HW processing unit 142 of the communication device 14 outputs a signal indicating that the band has changed, to the link band change detection unit 143, by performing S2 and S3 described above. Note that, however, the link HW processing unit 142 performs S2 and S3 described above, by replacing “coding scheme” with “decoding scheme”. Thereafter, the respective units of the communication device 14 perform S4 to S15 to transmit the traffic rate (e.g., 100 Mbps) and path ID 201 to the communication device 11 at the start point of the path 201 and the traffic rate (e.g., 100 Mbps) and path ID 202 to the communication device 12 at the start point of the path 202. The communication devices 11 and 12 at the start points of the paths 201 and 202 each perform S20 to S24 or S30 to S34, to thereby reduce the traffic rate to a rate within the received traffic rate (e.g., 100 Mbps) for the data on the corresponding one of the paths 201 and 202 indicated by received path IDs 201 and 202.

(6) Regarding Wireless Link

The description is given above of the case in which wireless links are included in the network according to the present exemplary embodiment. However, the network according to the present exemplary embodiment can include any link the band of which is changeable, without being limited to wireless links. For example, the network according to the present exemplary embodiment may include a bundle link instead of wireless links. A bundle link is a link configured by logically bundling one or more links up. A typical communication device connected to a bundle link (hereinafter referred to as a “typical bundle link communication device”) detects a failure (loss of signal or loss of light) in a link in a lower layer and changes the band of the bundle link. Upon change of the band of the bundle link, the communication devices 13, 14, and 15 connected to the bundle link can transmit data at the traffic rate that does not exceed the band, to the bundle link by performing S3 to S34 described above.

### Description of Effects

The network according to the present exemplary embodiment can more efficiently utilize the communication resources (communication devices and links) in the network than typical networks.

This is because the network according to the present exemplary embodiment instructs the communication device at the start point of each path transmitting data not to transmit data the data rate of which is larger than that possible to transmit through the link (wireless link), to thereby reduce the transmission data rate so as to prevent data from being discarded in the network. Consequently, each of the communication resources (communication devices and links) in the network according to the present exemplary embodiment, different from typical networks, does not unnecessarily transmit data to be discarded in the network and hence can use the processing capability for other processes. In other words, the network according to the present exemplary embodiment can more efficiently utilize the communication resources (links and communication devices) of the network than typical networks.

### Second Exemplary Embodiment

Next, a second exemplary embodiment of the present invention will be described.

[Description of Configuration]

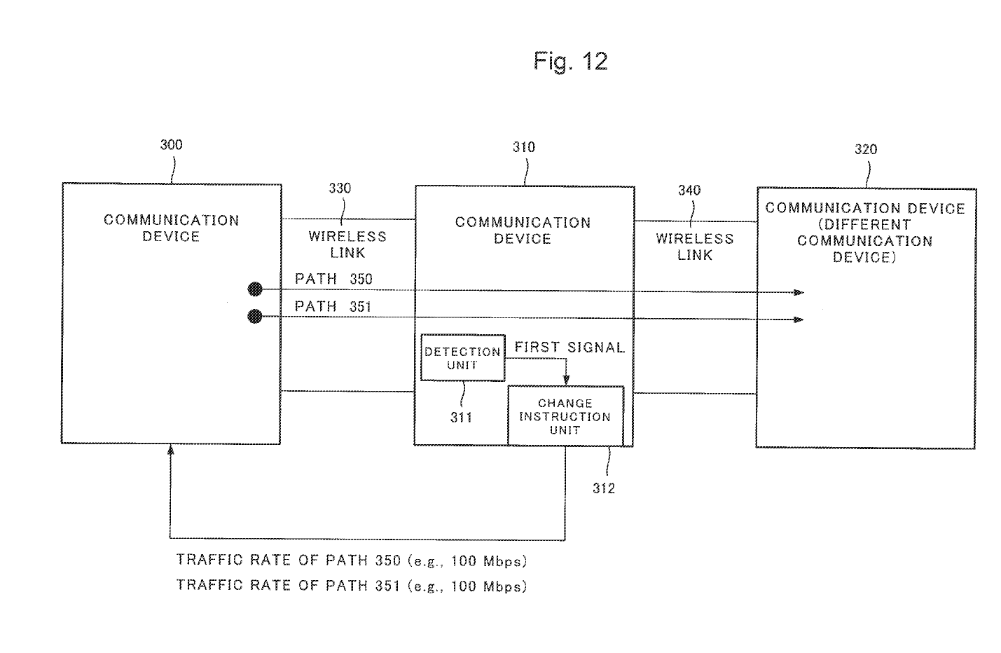

FIG. 12 is a diagram illustrating an example of a configuration of a network according to the second exemplary embodiment of the present invention.

The network according to the second exemplary embodiment includes a communication device 300, a communication device 310, and a communication device 320 as illustrated in FIG. 12.

The communication device 300 and the communication device 310 are connected to each other via a wireless link 330, and the communication device 310 and the communication device 320 are connected to each other via the wireless link 340.

Paths 350 and 351 are set between the communication device 300 and the communication device 320.

The communication device 300 is a communication device configured to transmit data on the (set) paths 350 and 351. The communication devices 310 and 320 are communication devices configured to receive the data on the (set) paths 350 and 351.

The communication device 310 includes a detection unit 311 and a change instruction unit 312. The communication device 320 may include a detection unit and a change instruction unit as with the communication device 310.

The detection unit 311 outputs a first signal in response to a change in band of the wireless link 340 connected to the other communication device 320 (for which the paths 350 and 351 are set). For example, the detection unit 311 may output the first signal upon decrease in band of the wireless link 340.

Upon input of the first signal, the change instruction unit 312 determines, for each of the paths 350 and 351, the traffic rate so that the total traffic rate does not exceed the band (after the change) of the wireless link 340.

The change instruction unit 312 transmits, to the communication device 300 which transmits the data on each of the paths 350 and 351, the determined traffic rate of the path.

The communication device 300 transmits the data on each of the paths 350 and 351 at a traffic rate within the traffic rate for the corresponding one of the paths 350 and 351 received from the change instruction unit 312.

[Description of Operations]

Description will be given below by assuming that the communication device 300 transmits the data on the path 350 at 300 Mbps and the data on the path 351 at 300 Mbps to the communication devices 310 and 320. Here, the band of each of the wireless links 330 and 340 is 1 Gbps. In other words, the wireless links 330 and 340 can each transmit data at 1 Gbps. The communication device 310 transmits the data at 600 Mbps in total (the data on the path 350 at 300 Mbps+the data on the path 351 at 300 Mbps) to the wireless link 340.

Assume that, in the above case, the band of the wireless link 340 changes from 1 Gbps to 200 Mbps due to deterioration in communication environment, and consequently, the data corresponding to 400 Mbps in total cannot be transmitted to the wireless link 340.

In this case, the detection unit 311 of the communication device 310 outputs the first signal to the change instruction unit 312 in response to the change in band of the wireless link 340 connected to the other communication device 320 (for which the paths 350 and 351 are set).

Upon input of the first signal, the change instruction unit 312 determines, for each of the paths 350 and 351, a traffic rate so that the total traffic rate does not exceed the band after the change of the wireless link 340 (200 Mbps). For example, the change instruction unit 312 may determine the traffic rate of the path 350 to be 100 Mbps and the traffic rate of the path 351 to be 100 Mbps.

The change instruction unit 312 then transmits the determined traffic rate of the path 350 (e.g., 100 Mbps) and the determined traffic rate of the path 351 (e.g., 100 Mbps) to the communication device 300 that transmits the data on each of the paths 350 and 351.

The communication device 300 then transmits the data on the path 350 to the communication device 310 at the traffic rate (e.g., 100 Mbps) of the path 350 received from the change instruction unit 312. Similarly, the communication device 300 transmits the data on the path 351 to the communication device 310 at the traffic rate (e.g., 100 Mbps) of the path 351 received from the change instruction unit 312. In other words, the communication device 300 transmits the data on each of the paths 350 and 351 at the traffic rate reduced to 100 Mbps from 300 Mbps.

Consequently, the communication device 300 does not unnecessarily transmit the data (corresponding to 400 Mbps) to be discarded.

### Description of Effects

The network according to the present exemplary embodiment can more efficiently utilize the communication resources (communication devices and links) in the network than typical networks.

This is because the network according to the present exemplary embodiment instructs the communication device for transmitting data, not to transmit data the data rate of which is larger than that possible to transmit through the link (wireless link), to thereby reduce the transmission data rate so as to prevent data from being discarded in the network. Consequently, each of the communication resources (communication devices and links) in the network according to the present exemplary embodiment, different from typical networks, does not unnecessarily transmit data to be discarded in the network and hence can use the processing capability for other processes. In other words, the network according to the present exemplary embodiment can more efficiently utilize the communication resources (links and communication devices) of the network than typical networks.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2014-068919 filed on Mar. 28, 2014, the disclosure of which is incorporated herein in its entirety by reference.

The whole or part of the exemplary embodiments disclosed above can be described as, but not limited to, the following supplementary notes.

### (Supplementary Note 1)

A communication device for which paths are set, the communication device comprising:

a detection means for outputting a first signal in response to a change in band of a link connected to a different one of the communication device for which the paths are set; and

a change instruction means for determining, for each of the paths, a traffic rate so that a total traffic rate does not exceed the band of the link after the change, upon input of the first signal, and transmitting the determined traffic rate of the path to a communication device transmitting data on the path.

### (Supplementary Note 2)

The communication device according to Supplementary Note 1, wherein the change instruction means transmits, to the communication device at a start point of each of the paths, the determined traffic rate of the path.

### (Supplementary Note 3)

The communication device according to any one of Supplementary Notes 1 and 2, wherein the detection means outputs the first signal upon decrease in the band.

### (Supplementary Note 4)

The communication device according to any one of Supplementary Notes 1 to 3, wherein the change instruction means determines the traffic rates to be equal when data on each of all the paths is a best-effort type.

### (Supplementary Note 5)

The communication device according to any one of Supplementary Notes 1 to 4, wherein the change instruction means determines the traffic rate of the path corresponding to data of a band guaranteed type among the one or more paths, to be a predetermined traffic rate.

### (Supplementary Note 6)

The communication device according to any one of Supplementary Notes 1 to 4, wherein the change instruction means determines the traffic rate of the path corresponding to data of a band guaranteed type and having a higher priority among the one or more paths, to be a predetermined traffic rate.

### (Supplementary Note 7)

A communication device for which a path is set, the communication device configured to transmit data on the path at a traffic rate within a received traffic rate of the path.

### (Supplementary Note 8)

A network comprising:

a first communication device configured to transmit data on a set path; and

a second communication device configured to receive the data on the path, wherein

the second communication device includes the communication device according to any one of Supplementary Notes 1 to 6, and

the first communication device includes the communication device according to Supplementary Note 7.

### (Supplementary Note 9)

A resource utilization method comprising:

outputting a first signal in response to a change in band of a link for which one or more paths are set;

determining, for each of the paths, a traffic rate so that a total traffic rate does not exceed the band after the change, upon input of the first signal, and outputting the determined traffic rate of the path; and

transmitting data on the path at a traffic rate within the input traffic rate of the path.

### (Supplementary Note 10)

The resource utilization method according to Supplementary Note 9, wherein the outputting of the first signal is performed upon decrease in the band.

### (Supplementary Note 11)

The resource utilization method according to any one of Supplementary Notes 9 and 10, wherein the determination of the traffic rates is performed so that the traffic rates are to be equal, when data of each of all the paths is a best-effort type.

### (Supplementary Note 12)

The resource utilization method according to any one of Supplementary Notes 9 to 11, wherein the determination is performed so that the traffic rate of the path corresponding to data of a band guaranteed type among the one or more paths is to be a predetermined traffic rate.

### (Supplementary Note 13)

The resource utilization method according to any one of Supplementary Notes 9 to 11, wherein the determination is performed so that a predetermined traffic rate is assigned to the path corresponding to data of a band guaranteed type and having a higher priority among the one or more paths.

### REFERENCE SIGNS LIST

11 to 16, 51, 53, 56, 300, 310, 320 Communication device
20 NMS (network management system)
60, 61, 350, 351 Path
70, 103 to 111 Link
72 Variable link
110, 130 Link information storage unit
111, 121, 131 Path information storage unit
114, 124, 134 Band change instruction unit
115, 125 Switch HW (hardware) processing unit
132 Link HW processing unit
133 Link band change detection unit
136 Path-link mapping information
311 Detection unit
312 Change instruction unit
330, 340 Wireless link

1. A communication device for which paths are set, the communication device comprising:
a detection unit for outputting a first signal in response to a change in band of a link connected to a different one of the communication device for which the paths are set; and
a change instruction unit for determining, for each of the paths, a traffic rate so that a total traffic rate does not exceed the band of the link after the change, upon input of the first signal, and transmitting the determined traffic rate of the path to a communication device transmitting data on the path.

2. The communication device according to claim 1, wherein the change instruction unit transmits, to the communication device at a start point of each of the paths, the determined traffic rate of the path.

3. The communication device according to claim 1, wherein the detection unit outputs the first signal upon decrease in the band.

4. The communication device according to claim 1, wherein the change instruction unit determines the traffic rates to be equal when data on each of all the paths is a best-effort type.

5. The communication device according to claim 1, wherein the change instruction unit determines the traffic rate of the path corresponding to data of a band guaranteed type among the one or more paths, to be a predetermined traffic rate.

6. The communication device according to claim 1, wherein the change instruction unit determines the traffic rate of the path corresponding to data of a band guaranteed type and having a higher priority among the one or more paths, to be a predetermined traffic rate.

7. A communication device for which a path is set, the communication device configured to transmit data on the path at a traffic rate within a received traffic rate of the path.

8. A network comprising:
a first communication device configured to transmit data on a set path; and
a second communication device configured to receive the data on the path, wherein the second communication device includes the communication device according to claim 1, and
the first communication device includes the communication device for which a path is set, the communication device configured to transmit data on the path at a traffic rate within the received traffic rate of the path.

9. A resource utilization method comprising:
outputting a first signal in response to a change in band of a link for which one or more paths are set;
determining, for each of the paths, a traffic rate so that a total traffic rate does not exceed the band after the change, upon input of the first signal, and outputting the determined traffic rate of the path; and
transmitting data on the path at a traffic rate within the input traffic rate of the path.

10. The resource utilization method according to claim 9, wherein the outputting of the first signal is performed upon decrease in the band.

11. The resource utilization method according to claim 9, wherein the determination of the traffic rates is performed so that the traffic rates are to be equal, when data of each of all the paths is a best-effort type.

12. The resource utilization method according to claim 9, wherein the determination is performed so that the traffic rate of the path corresponding to data of a band guaranteed type among the one or more paths is to be a predetermined traffic rate.

13. The resource utilization method according to claim 9, wherein the determination is performed so that a predetermined traffic rate is assigned to the path corresponding to data of a band guaranteed type and having a higher priority among the one or more paths.
